(19) United States
(12) Patent Application Publication
(10) Pub. No.: US 2025/0074453 A1
(43) Pub. Date: Mar. 6, 2025

(54) RIGOROUS DEVELOPMENT AND ANALYSYS OF AUTONOMOUS DRIVING REQUIREMENTS AND TEST CASES USING MULTI-DOMAIN ONTOLOGIES

(71) Applicant: GM Global Technology Operations LLC, Detroit, MI (US)

(72) Inventors: Ramesh Sethu, Troy, MI (US); Rami Ismail Debouk, Warren, MI (US); Joseph D'Ambrosio, Clarkston, MI (US)

(21) Appl. No.: 18/457,609

(22) Filed: Aug. 29, 2023

(51) Int. Cl. B60W 60/00

(52) U.S. Cl. CPC B60W 60/001; B60W 2556/00

(57) ABSTRACT

The method for autonomous driving includes receiving vehicle data about an autonomous vehicle, creating, using the vehicle data, a multi-domain ontology data structure. The multi-domain ontology data structure includes information about tasks, objects, missions, events, and responses of the autonomous vehicle in a plurality of operational design domains. The method further includes generating use cases, requirements, and test cases for the autonomous vehicle based on the multi-domain ontology data structure. The method may include controlling the autonomous vehicle in accordance with the use cases generated using the multi-domain ontology data structure.

### INTRODUCTION

The present disclosure relates to a system and method for rigorous development and analysis of autonomous driving requirements and test cases using multi-domain cases.

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

Some vehicles include autonomous driving systems. These systems (especially for offroad vehicles) should comprehend and handle several objects (e.g., rocks, craters, rock fields, etc.), low level tasks (e.g., move steadily on grounds with varying slopes and roughness, avoid obstacles, negotiate rocks), and high-level missions (e.g., cross muddy terrain, traverse craters, etc.). It is therefore desirable to develop a method and system for analyzing the requirements for an autonomous vehicle to handle these objects, low level tasks, and high-level missions.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for autonomous driving. The method includes receiving vehicle data about an autonomous vehicle and creating, using the vehicle data (e.g., vehicle requirements), a multi-domain ontology data structure. The multi-domain ontology data structure includes information about tasks, objects, missions, events, and responses of the autonomous vehicle in a plurality of operational design domains. The method further includes generating use cases, test cases, and/or requirements for the autonomous vehicle based on the multi-domain ontology data structure. The method further includes describing the behavior of the autonomous vehicle under various operational design domains through use cases. The method may include controlling the autonomous vehicle in accordance with the use cases, test cases, and/or requirements previously generated using the multi-domain ontology data structure. Other embodiments of this aspect include corresponding computer systems, apparatus, and computer programs recorded on one or more computer storage devices, each configured to perform the actions of the methods. The method described in this paragraph improves autonomous vehicle technology by describing the behavior of the autonomous vehicle using the multi-domain ontology data structure, thereby allowing efficient control of the autonomous vehicle in various operational design domains (ODD) conditions.

Implementations may include one or more of the following features. The multi-domain ontology data structure includes a description of each of the plurality of operational design domains in terms of a plurality of ontological concepts, and plurality of ontological concepts are expressed as constrained parameters. The plurality of autonomous driving requirements describes at least one action that the autonomous vehicle is expected to perform based on an external environment conditions and vehicle states of the autonomous vehicle. The vehicle data includes a description of each of the plurality of operational design domains, a plurality of vehicle states of the autonomous vehicle, vehicle responses and vehicle actions, and object and event detection and response (OEDR) data. The multi-domain ontology data structure includes a plurality of concepts identifiers, the plurality of concepts identifiers includes an element and a type. The multi-domain ontology data structure further includes a hierarchical relationship connecting the elements to the types, and parameters and constraints relating to the elements. The uses cases are distinct interaction sequences between external agents enabled by a function of the autonomous vehicle. The method may include generating test cases for the autonomous vehicle based on the multi-domain ontology data structure. Implementations of the described techniques may include hardware, a method or process, or computer software on a computer-accessible medium. A subset of vehicle data linked to the ontology could be captured and monitored to help ensure the vehicle was not operating outside its operational design domain.

The present disclosure also describes a tangible, non-transitory, machine-readable medium, comprising machine-readable instructions, that when executed by a processor, cause the processor to execute the method described above. The present disclosure also describes an autonomous driving system. The autonomous driving system includes sensors and a controller in communication with the sensors. The controller is programmed to execute the method described above.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the presently disclosed system and method are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1 is a block diagram depicting an embodiment of a vehicle including an autonomous driving system.

FIG. 2 is a flowchart of a method for creatin a multi-domain ontology data structure.

### DETAILED DESCRIPTION

Reference will now be made in detail to several examples of the disclosure that are illustrated in accompanying drawings. Whenever possible, the same or similar reference numerals are used in the drawings and the description to refer to the same or like parts or steps.

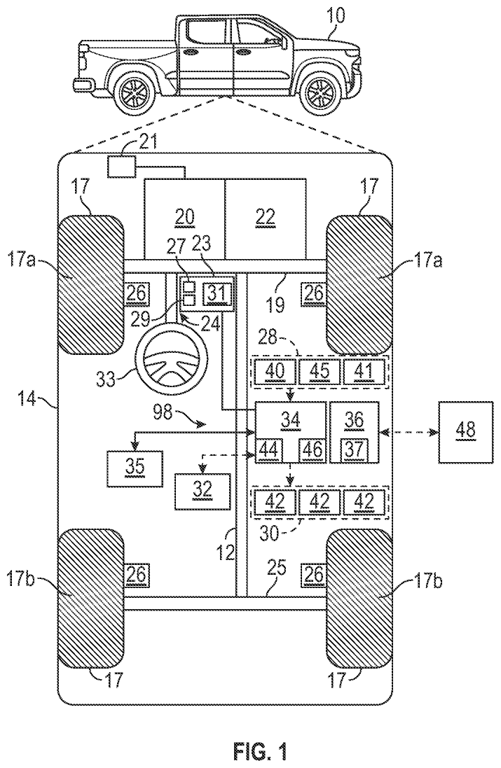

With reference to FIG. 1, a vehicle 10 generally includes a chassis 12, a body 14, front and rear wheels 17 and may be referred to as a vehicle system. In the depicted embodiment, the vehicle 10 includes two front wheels 17a and two rear wheels 17b. The body 14 is arranged on the chassis 12 and substantially encloses components of the vehicle 10. The body 14 and the chassis 12 may jointly form a frame. The wheels 17 are each rotationally coupled to the chassis 12 near a respective corner of the body 14. The vehicle 10 includes a front axle 19 coupled to the front wheels 17a and a rear axle 25 coupled to the rear wheels 17b.

The vehicle 10 is an autonomous vehicle, and an automated driving system (ADS) 98 is incorporated into the vehicle 10. The system 98 may be referred to as the system or the system for controlling autonomous driving. The vehicle 10 is, for example, a vehicle that is automatically controlled to carry passengers from one location to another. The vehicle 10 is depicted in the illustrated embodiment as a pickup truck, but it should be appreciated that other vehicles including, trucks, sedans, coupes, sport utility vehicles (SUVs), recreational vehicles (RVs), etc., may also be used. In an embodiment, the vehicle 10 may include a so-called a Level Two, a Level Three, Level Four, or Level Five driving automation system. A Level Four system indicates “high automation,” referring to the driving mode-specific performance by an automated driving system of aspects of the dynamic driving task, even if a human driver does not respond appropriately to a request to intervene. A Level Five system indicates “full automation,” referring to the full-time performance by an automated driving system of aspects of the dynamic driving task under a number of roadway and environmental conditions that can be managed by a human driver. In Level 3 vehicles, the ADS 98 performs the entire dynamic driving task (DDT) within the area that it is designed to do so. The vehicle operator is only expected to be responsible for the DDT-fallback when the ADS 98 essentially “asks” the driver to take over if something goes wrong or the vehicle is about to leave the zone where it is able to operate. In Level 2 vehicles, systems provide steering, brake/acceleration support, lane centering, and adaptive cruise control. However, even if these systems are activated, the vehicle operator at the wheel must be driving and constantly supervising the automated features.

As shown, the vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an electric machine such as a traction motor and/or a fuel cell propulsion system. The vehicle 10 may further include a battery (or battery pack) 21 electrically connected to the propulsion system 20. Accordingly, the battery 21 is configured to store electrical energy and to provide electrical energy to the propulsion system 20. In certain embodiments, the propulsion system 20 may include an internal combustion engine. The transmission system 22 is configured to transmit power from the propulsion system 20 to the vehicle wheels 17 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 17. The brake system 26 may, in various embodiments, include friction brakes, brake by wire, a regenerative braking system such as an electric machine, and/or other appropriate braking systems. The steering system 24 influences the position of the vehicle wheels 17 and may include a steering wheel 33. While depicted as including a steering wheel 33 for illustrative purposes, in some embodiments contemplated within the scope of the present disclosure, the steering system 24 may not include a steering wheel 33.

The sensor system 28 includes one or more sensors 40 (i.e., sensing devices) that sense observable conditions of the exterior environment and/or the interior environment of the vehicle 10. The sensors 40 are in communication with the controller 34 and may include, but are not limited to, one or more radars, one or more light detection and ranging (lidar) sensors, one or more proximity sensors, one or more odometers, one or more ground penetrating radar (GPR) sensors, one or more steering angle sensors, Global Navigation Satellite System (GNSS) transceivers (e.g., one or more global positioning systems (GPS) transceivers), one or more tire pressure sensors, one or more cameras 41 (e.g., eye tracker), one or more gyroscopes, one or more accelerometers, one or more inclinometers, one or more speed sensors, one or more ultrasonic sensors, one or more inertial measurement units (IMUs), one or more night-vision devices, thermal imaging sensors, and/or other sensors. Each sensor 40 is configured to generate a signal that is indicative of the sensed observable conditions of the exterior environment and/or the interior environment of the vehicle 10. Because the sensor system 28 provides data to the controller 34, the sensor system 28 and its sensors 40 are considered sources of information (or simply sources). The vehicle 10 and/or system 98 does not include light sensors capable of detecting light inside the vehicle 10.

The actuator system 30 includes one or more actuator devices 42 that control one or more vehicle features such as, but not limited to, the propulsion system 20, the transmission system 22, the steering system 24, and the brake system 26. In various embodiments, the vehicle features may further include interior and/or exterior vehicle features such as, but are not limited to, doors, a trunk, and cabin features such as air, music, lighting, etc.

The data storage device 32 stores data for use in automatically controlling the vehicle 10. In various embodiments, the data storage device 32 stores defined maps of the navigable environment. In various embodiments, the defined maps may be predefined by and obtained from a remote system. For example, the defined maps may be assembled by the remote system and communicated to the vehicle 10 (wirelessly and/or in a wired manner) and stored in the data storage device 32. The data storage device 32 may be part of the controller 34, separate from the controller 34, or part of the controller 34 and part of a separate system.

The vehicle 10 may further include one or more airbags 35 in communication with the controller 34 or another controller of the vehicle 10. The airbag 35 includes an inflatable bladder and is configured to transition between a stowed configuration and a deployed configuration to cushion the effects of an external force applied to the vehicle 10. The sensors 40 may include an airbag sensor, such as an IMU, configured to detect an external force and generate a signal indicative of the magnitude of such external force. The controller 34 is configured to command the airbag 35 to deploy based on the signal from one or more sensors 40, such as the airbag sensor. Accordingly, the controller 34 is configured to determine when the airbag 35 has been deployed.

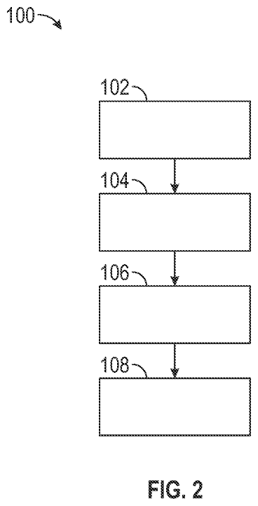

The controller 34 includes at least one processor 44 and a non-transitory computer readable storage device or media 46. The processor 44 may be a custom made or commercially available processor, a central processing unit (CPU), a graphics processing unit (GPU), an auxiliary processor among several processors associated with the controller 34, a semiconductor-based microprocessor (in the form of a microchip or chip set), a macroprocessor, a combination thereof, or generally a device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 34 in controlling the vehicle 10. The controller 34 of the vehicle 10 may be referred to as a vehicle controller and may be programmed to execute a method 100 (FIG. 2) as described in detail below.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although a single controller 34 is shown in FIG. 1, embodiments of the vehicle 10 may include a plurality of controllers 34 that communicate over a suitable communication medium or a combination of communication mediums and that cooperate to process the sensor signals, perform logic, calculations, methods, and/or algorithms, and generate control signals to automatically control features of the vehicle 10. In various embodiments, one or more instructions of the controller 34 are embodied in the control system 98.

The vehicle 10 includes a user interface 23, which may be a touchscreen in the dashboard. The user interface 23 may include, but is not limited to, an alarm, such as one or more speakers 27 to provide an audible sound, haptic feedback in a vehicle seat or other object, one or more displays 29, one or more microphones 31 and/or other devices suitable to provide a notification to the vehicle user of the vehicle 10. The user interface 23 is in electronic communication with the controller 34 and is configured to receive inputs by a vehicle occupant 11 (e.g., a vehicle driver or a vehicle passenger). For example, the user interface 23 may include a touch screen and/or buttons configured to receive inputs from a vehicle occupant 11. Accordingly, the controller 34 is configured to receive inputs from the user via the user interface 23. The vehicle 10 may include one or more displays 29 configured to display information to the vehicle occupant 11 (e.g., vehicle operator or passenger) and may be a head-up display (HUD).

The communication system 36 is in communication with the controller 34 and is configured to wirelessly communicate information to and from other remote vehicles 48, such as but not limited to, other vehicles (“V2V” communication), infrastructure (“V2I” communication), remote systems at a remote call center (e.g., ON-STAR by GENERAL MOTORS) and/or personal electronic devices, such as a mobile phone. In the present disclosure, the term “remote vehicle” means a vehicle, such as a car, configured to transmit one or more signals to the vehicle 10 while not physically connected to the vehicle 10. In certain embodiments, the communication system 36 is a wireless communication system configured to communicate via a wireless local area network (WLAN) using IEEE 802.11 standards or by using cellular data communication. However, additional, or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards. Accordingly, the communication system 36 may include one or more antennas and/or communication transceivers 37 for receiving and/or transmitting signals, such as cooperative sensing messages (CSMs). The communication transceivers 37 may be considered sensors 40. The communication system 36 is configured to wirelessly communicate information between the vehicle 10 and another vehicle. Further, the communication system 36 is configured to wirelessly communicate information between the vehicle 10 and infrastructure or other vehicles.

FIG. 2 is a flowchart of a method 100 for creating an ontology database. The method 100 begins at block 102. Block 102 entails receiving vehicle data (i.e., vehicle requirements) about the vehicle 10 and creating a multi-domain ontology data structure using the vehicle data. The multi-domain ontology data structure includes information about tasks, objects, missions, events, and responses of the autonomous vehicle in a plurality of operational design domains (ODD). Specifically, the multi-domain ontology data structure has specific components to describe various elements of the ODD and Object and Event Detection and Response (OEDR) parametrically. An onboard monitoring system may compare ontology related vehicle data to the offboard created ontology.

ODDs can be described using ontological concepts such as weather, lighting, roadways, lanes, traffic participants, lane following behaviors, maintaining safe distance, lane change, stopping, etc. The components are connected to each other in a hierarchical fashion. For example, a scenario ODD may include a first hierarchy that describes the surface, the static environment, and the dynamic environment around the vehicle 10. The surface around the vehicle 10 may be described in terms of terrain, soil, and obstacles. The soil may be described by type (e.g., loose, firm, gravel, etc.). The data about static environment around the vehicle 10 may include information about the lightning and the dust around the vehicle 10. The data about the dynamic environment around the vehicle 10 may include information about humans around the vehicle 10 and information about the vehicle 10 itself.

The multi-domain ontology data structure describes a variety of ADS related concepts. These concepts are rigorously and precisely described in the multi-domain ontology database by using parameters and constraints relating to parameter valuations. The parametric description of the ontological concepts may be expressed in numerical and/or Boolean parameters. Thus, the multi-domain ontology data structure includes a number of elements that correspond to different types of entities that the ADS 98 deals with, such as driving surfaces, rocks and hills, depressions and craters, weather, lightning, dust, etc. The elements are stored and organized on different levels of abstractions. For example, the elements may be organized hierarchically (e.g., a rock is an obstacle, and a hill is a pile of rocks) or orthogonally (e.g., a driving surface has an inclination and contains soft soil, and a rock has a shape and size and orientation). The parameters values are related in a way that can be captured as constraints. In other words, the elements may be associated with parameters and constraints relating to different parameters (e.g., a surface has a slope of ten degrees, a crater has a radius of fifty meters, a vehicle speed cannot exceed fifteen meters per second). A list of application program interfaces (APIs) may allow access to different elements in the multi-domain ontology data structure for further processing.

To create the multi-domain ontology data structure, the following inputs are received: ODD description, OEDR data, ADS vehicle states, and responses or actions. Then, an analysis is performed to output a set of concept identifiers (called elements and their types), hierarchical relationships connecting the elements of the different types (e.g., a rock is an obstacle, or a pile of rocks is a hill), and parameters and constraints relating to the parameters and the concepts. The multi-domain ontology data structure may be designed in different formats, such as a unified modeling language (UML) class diagram with constrains and/or a formal logical system. The construction process for creating the multi-domain ontology data structure is semi-automatic. An analysis is performed to check for consistency and completeness. Once the multi-domain ontology data structure is created, the method 100 proceeds to block 104.

Block 104 entails generating use cases using the multi-domain ontology data structure. Use cases capture key end-to-end functionality involving external agents interacting with the ADS 98. These external agents may be human users or other subsystems. The use cases enumerate distinct interaction sequences between external agents and the ADS feature. As non-limiting examples, the use cases define or identify the following: a) system boundaries including agents triggering it and agents affected by it; b) preconditions that the agents need to satisfy; and c) the triggers or inputs the agents provide, such as the environmental conditions. The ADS 98 has multiple input and output interfaces to receive and send out commands to other external systems. For every input/output interface of the ADS 98, there would be one or more use cases.

The multi-domain ontology data structure contains comprehensive information about inputs, environment, vehicle state information, and outputs produced by an ADS feature. To develop the use cases, every external interface to the ADS 98 is extracted from the multi-domain ontology data structure. Then, the possible combinations of input, output interfaces and vehicle states are enumerated along with their constraints. One or more tasks are associated with each of these combinations. Next, the inconsistent combinations are filtered out by constraint solving. The human inputs are then refined to arrive at the use cases.

Block 106 entails developing or generating requirements for autonomous driving. The requirements range over external as well as internal states and conditions. Requirements describe what action(s) the ADS 98 is expected to perform under what conditions based on the external environment and states of the vehicle 10. For instance, the vehicle 10 should avoid rocks of a predetermined size when traversing a terrain with a slope that is less than a predetermined slope threshold. These requirements consider explicitly many elements (e.g., rocks, terrain, traverse, avoid) and implicitly other elements (e.g., lightning, weather). The multi-domain ontology data structure includes comprehensive information about all of these elements. The multi-domain ontology data structure supports systematic enumeration of these elements at different hierarchical levels of the ontology for developing requirements. The requirements developer uses the multi-domain ontology data structure to fill in new requirements, remove inconsistencies, and incompleteness.

Block 106 includes two modules, namely: an elicitation module and an evaluation module. Both of these modules use the multi-domain ontology data structure. The elicitation module involves user inputs, whereas the evaluation module outputs the quality and maturity level of the requirements. The elicitation module starts with an input by the user. This user input is an initial set of requirements. The user continuously interacts with the elicitation module to provide information about the requirements and provide feedback. For example, the user may add, delete, and/or revise new requirements. The user may extract gaps in requirements and/or parameter ranges. Further, the user may check for consistency and completeness. The hierarchical ontological structure available in the multi-domain ontology data structure enables the operations of the elicitation module. An analysis module analyses existing requirements and the user inputs to identify gaps, inconsistencies and provide feedback or updates the requirements.

Block 108 entails generating test cases for the autonomous vehicle based on the multi-domain ontology data structure. The test cases are instantiations of specific values to the different elements in the multi-domain ontology data structure. The multi-domain ontology data structure contains all elements along with their parameters and value ranges. For test cases, the output or response elements are not considered. The rest of the elements (except for the output and response elements) are inputs and therefore are tested along with the constraints. Another input to the testing procedure is the amount of coverage. The coverage is given by the parameter ranges of the individual elements and the combination of elements (e.g., pairwise coverage). The element description decides the hierarchical level of the element as well. The higher the hierarchical level, the fewer combinations will be covered.

The testing procedure includes a test data development (TDD) step and an expected output generation (EOG) step. A variety of techniques may be employed for the TDD step. For example, the TDD step may entail interactive enumerating test inputs and measuring coverage. Alternatively, the design of experiments (DoE) techniques may be used to perform the TDD step. In another example, a selection of edge cases may be used to perform the TDD step. The EOG step takes the additional input of the requirements. Further, the EOG step extracts the response or output element corresponding to the test data to generate the test cases. Block 108 may also entail describing the behavior of the autonomous vehicle in accordance with the use cases, requirements, and/or test previously generated using the multi-domain ontology data structure. In other words, at block 108, the behavior of the autonomous vehicle is described under various operational design domains through use cases. Further, block 108 may entail controlling the autonomous vehicle in accordance with the use cases, requirements, and/or test previously generated using the multi-domain ontology data structure.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the presently disclosed system and method that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

The drawings are in simplified form and are not to precise scale. For purposes of convenience and clarity only, directional terms such as top, bottom, left, right, up, over, above, below, beneath, rear, and front, may be used with respect to the drawings. These and similar directional terms are not to be construed to limit the scope of the disclosure in any manner.

Embodiments of the present disclosure are described herein. It is to be understood, however, that the disclosed embodiments are merely examples and other embodiments can take various and alternative forms. The figures are not necessarily to scale; some features could be exaggerated or minimized to display details of particular components. Therefore, specific structural and functional details disclosed herein are not to be interpreted as limiting, but merely as a representative basis for teaching one skilled in the art to variously employ the presently disclosed system and method. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Embodiments of the present disclosure may be described herein in terms of functional and/or logical block components and various processing steps. It should be appreciated that such block components may be realized by a number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with a number of systems, and that the systems described herein are merely exemplary embodiments of the present disclosure.

For the sake of brevity, techniques related to signal processing, data fusion, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that alternative or additional functional relationships or physical connections may be present in an embodiment of the present disclosure.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A method for autonomous driving:
receiving vehicle requirements about an autonomous vehicle;
creating, using the vehicle requirements, a multi-domain ontology data structure, wherein the multi-domain ontology data structure includes information about tasks, objects, missions, events, and responses of the autonomous vehicle in a plurality of operational design domains;
generating use cases for the autonomous vehicle based on the multi-domain ontology data structure; and
describing a behavior of the autonomous vehicle under various operational design domains through use cases.

2. The method of claim 1, wherein the multi-domain ontology data structure includes a description of each of the plurality of operational design domains in terms of a plurality of ontological concepts, and plurality of ontological concepts are expressed as constrained parameters.

3. The method of claim 2, further comprising generating a plurality of autonomous driving requirements using the multi-domain ontology data structure, wherein the plurality of autonomous driving requirements describes at least one action that the autonomous vehicle is expected to perform based on an external environment conditions and vehicle states of the autonomous vehicle.

4. The method of claim 3, wherein the vehicle data includes a description of each of the plurality of operational design domains, a plurality of vehicle states of the autonomous vehicle, vehicle responses and vehicle actions, and Object and Event Detection and Response (OEDR) data.

5. The method of claim 4, wherein the multi-domain ontology data structure includes a plurality of concepts identifiers, the plurality of concepts identifiers includes an element and a type, the multi-domain ontology data structure further includes a hierarchical relationship connecting the elements to the types, and parameters and constraints relating to the elements.

6. The method of claim 5, wherein the uses cases are distinct interaction sequences between external agents enabled by a function of the autonomous vehicle.

7. The method of claim 6, further comprising generating test cases for the autonomous vehicle based on the multi-domain ontology data structure.

8. An automated driving system, comprising:
a plurality of sensors;
a controller including a processor, wherein the controller is in communication with the plurality of sensors and is programmed to:
receive vehicle data about an autonomous vehicle;
create, using the vehicle data, a multi-domain ontology data structure, wherein the multi-domain ontology data structure includes information about tasks, objects, missions, events, and responses of the autonomous vehicle in a plurality of operational design domains;
generate use cases for the autonomous vehicle based on the multi-domain ontology data structure; and
describe a behavior of autonomous vehicle in accordance with the use cases generated using the multi-domain ontology data structure.

9. The automated driving system of claim 8, wherein the multi-domain ontology data structure includes a descriptions of each of the plurality of operational design domains in terms of a plurality of ontological concepts, and the plurality of ontological concepts are expressed as constrained parameters.

10. The automated driving system of claim 9, wherein the automated driving system requirements describe at least one action that the autonomous vehicle is expected to perform based on an external environment conditions and vehicle states of the autonomous vehicle.

11. The automated driving system of claim 10, wherein the vehicle data includes a description of each of the plurality of operational design domains, a plurality of vehicle states of the autonomous vehicle, vehicle responses and vehicle actions, and Object and Event Detection and Response (OEDR) data.

12. The automated driving system of claim 11, wherein the multi-domain ontology data structure includes a plurality of concepts identifiers, the plurality of concepts identifiers includes an element and a type, the multi-domain ontology data structure further includes a hierarchical relationship connecting the elements to the types, and parameters and constraints relating to the elements.

13. The automated driving system of claim 12, wherein the use cases are distinct interaction sequences between external agents enabled by a function of the autonomous vehicle.

14. The automated driving system of claim 13, wherein the controller is programmed to capture a subset of vehicle data linked to the multi-domain ontology data structure and monitored to help ensure a vehicle is not operating outside an operational design domain.

15. A tangible, non-transitory, machine-readable medium, comprising machine-readable instructions, that when executed by a processor, cause the processor to:
receive vehicle requirements about an autonomous vehicle;
create, using the vehicle requirements, a multi-domain ontology data structure, wherein the multi-domain ontology data structure includes information about tasks, objects, missions, events, and responses of the autonomous vehicle in a plurality of operational design domains;
generate use cases for the autonomous vehicle based on the multi-domain ontology data structure; and
describe a behavior of the autonomous vehicle in accordance with the use cases generated using the multi-domain ontology data structure.

16. The tangible, non-transitory, machine-readable medium of claim 15, wherein the multi-domain ontology data structure includes a description of each of the plurality of operational design domains in terms of a plurality of ontological concepts, and the plurality of ontological concepts are expressed as constrained parameters.

17. The tangible, non-transitory, machine-readable medium of claim 16, wherein the tangible, non-transitory, machine-readable medium further comprising machine-readable instructions, that when executed by the processor, causes the processor to generate autonomous driving requirements using the multi-domain ontology data structure, and the autonomous driving requirements describes at least one action that the autonomous vehicle is expected to perform based on an external environment conditions and vehicle states of the autonomous vehicle.

18. The tangible, non-transitory, machine-readable medium of claim 17, wherein the vehicle data includes a description of each of the plurality of operational design domains, a plurality of vehicle states of the autonomous vehicle, vehicle responses and vehicle actions, and Object and Event Detection and Response (OEDR) data.

19. The tangible, non-transitory, machine-readable medium of claim 18, wherein the multi-domain ontology data structure includes a plurality of concepts identifiers, the plurality of concepts identifiers includes an element and a type, the multi-domain ontology data structure further includes a hierarchical relationship connecting the elements to the types, and parameters and constraints relating to the elements.

20. The tangible, non-transitory, machine-readable medium of claim 19, wherein the uses cases are distinct interaction sequences between external agents enabled by a function of the autonomous vehicle.
